(19) United States
(12) Patent Application Publication
(10) Pub. No.: US 2008/0082936 A1
(43) Pub. Date: Apr. 3, 2008

(54) Method and system for displaying alternative task data on mobile electronic device

(76) Inventor: Richard Eric Helvick, Portland, OR (US)

Correspondence Address: SHARP LABORATORIES OF AMERICA, INC., 1320 PEARL ST., SUITE 228, BOULDER, CO, 80302, US

(21) Appl. No.: 11/529,135

(22) Filed: Sep. 28, 2006

(51) Int. Cl. G06F 3/00

(52) U.S. Cl. 715/779; 715/700

(57) ABSTRACT

Mobile electronic device and method therefor that in a minimally disruptive way informs the user of alternative task data and provides an on-screen mechanism for the user to select alternative tasks or return to non-disruptive viewing of current task data. Once such method comprises rendering on a display of a mobile electronic device in a first size window data from a first task, detecting on the device an event involving a second task and, in response to the event, rendering on the display of the device in a second size window the data from the first task while rendering adjacent to the second size window a dashboard adapted to inform the user of the event. The dashboard may include event information and a menu adapted to receive a user selection respecting the event.

### BACKGROUND OF THE INVENTION

The present invention relates to multitasking on a mobile electronic device and, more particularly, to a method and system for displaying alternative task data to a user of a mobile electronic device and allowing selection of alternative tasks with minimal disruption to the display of current task data.

Modern mobile electronic devices, such as mobile phones, pocket PCs and PDAs, enable several tasks, such as software applications, software processes and video channels, to run simultaneously. Examples of software applications that support tasks include telephony clients, messaging clients video players and calendar services. While the mobile electronic device user is interfacing with one task on the display, an event may occur within another task that may require the immediate attention of the user. Conventionally, the user is notified of the event via a popup window displayed on top of the task window with which the user is interfacing.

Popup windows can prove highly disruptive to the user's experience. For example, if a popup window is displayed over a broadcast video window being viewed by the user, the user may miss video frames while dealing with the popup window. The user may become particularly annoyed if the popup window notifies the user of an event the user regards as unimportant. More generally, popup windows can be annoying to a user who is interfacing with any type of task since he or she must contend with the popup window before reengaging with the task of interest to the user.

### SUMMARY OF THE INVENTION

The invention, in a basic feature, provides a mobile electronic device and a method therefor that in a minimally disruptive way informs the user of alternative task data and provides an on-screen mechanism for the user to select alternative tasks or return to non-disruptive viewing of current task data.

Once such method comprises rendering on a display of a mobile electronic device in a first size window data from a first task, detecting on the device an event involving a second task and, in response to the event, rendering on the display of the device in a second size window the data from the first task while rendering adjacent to the second size window a dashboard adapted to inform the user of the event.

One such mobile electronic device comprises a processor running a display manager and first and second tasks, and a display communicatively coupled with the processor and adapted to render data involving the first and second tasks under control of the display manager, wherein in response to an event involving the second task the display manager is adapted to reduce the size of a window on the display rendering data from the first task and render adjacent to the window a dashboard adapted to inform a user of the event.

The dashboard may include event information and a menu adapted to receive a user selection respecting the event.

The tasks may be software applications, software processes or video channels.

The data may be frames from a video feed.

The event may be one of an incoming call, an incoming text message, an incoming image and a calendar event.

In the method, the method may further comprise rendering on the display in a window of a third size the data from the first task in response to one of a user selection on the dashboard, expiration of a user selection time limit and termination of the event. The first and third size windows may be full-screen windows. The data rendered in first and third size windows may include all lines of a video feed while the data rendered in the second size window may include selected lines of the video feed.

In the mobile electronic device, the display manager may be further adapted to increase the size of the window in response to one of a user selection on the dashboard, expiration of a user selection time limit and termination of the event. The size of the window prior to reduction and after increase may be full-screen. The data rendered in the window prior to reduction and after increase may include all lines of a video feed while the data rendered in the window after reduction and prior to increase may include selected lines of the video feed.

The selected lines may be taken in substantially equal proportion across the video feed.

Another such mobile electronic device comprises a processor running a display manager and first and second tasks, and a display communicatively coupled with the processor and adapted to render data from the first and second tasks under control of the display manager, wherein the display manager is adapted to render data from the first task in a window and render adjacent to the window a dashboard having a menu adapted to receive a user selection, and wherein in response to a user selection the display manager is adapted to render data from the second task in the window in lieu of the data from the first task. The menu may, for example, permit user selection of one of email subjects, market data and news headlines, or may permit user selection of an alternative video channel.

These and other aspects of the invention will be better understood by reference to the detailed description of the preferred embodiment read in conjunction with the drawings briefly described below. Of course, the scope of the invention is defined by the appended claims.

### BRIEF DESCRIPTION OF THE DRAWINGS

FIG. 1 shows a communication system including a mobile electronic device in one embodiment of the invention.

FIG. 2A shows an exemplary display screen with a full-screen image window on a mobile electronic device in one embodiment of the invention.

FIG. 2B shows an exemplary display screen with a reduced image window and a dashboard on a mobile electronic device in one embodiment of the invention.

FIG. 3 is a diagram of a process flow performed by a display manager on a mobile electronic device in one embodiment of the invention.

FIG. 4A shows an exemplary display screen with a reduced image window and a dashboard having a video channel user selection capability on a mobile electronic device in another embodiment of the invention.

FIG. 4B shows an exemplary display screen with a reduced image window and a dashboard having a topic user selection capability on a mobile electronic device in another embodiment of the invention.

### DETAILED DESCRIPTION OF A PREFERRED EMBODIMENT

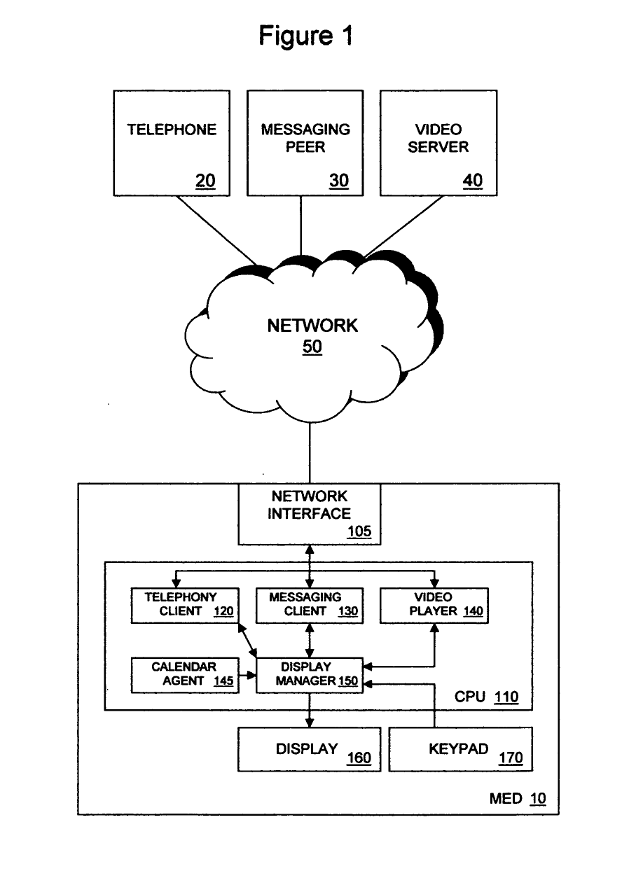

In FIG. 1, a communication system including a mobile electronic device 10 is shown in one embodiment of the invention. Mobile electronic device 10 is communicatively coupled with a telephone 20, a messaging peer 30 and a video server 40 via communication network 50. Telephone 20, messaging peer 30 and video server 40 may reside on one or more networked devices within one or more of a home office network, an enterprise network, and a service provider network, for example. Telephone 20 peers with telephony client 120 on mobile electronic device 10 for traditional voice calling functions. Messaging peer 30 peers with messaging client 130 on mobile electronic device 10 for multimedia communication functions, which may include video calling, text messaging and digital image communication, for example. Video server 40 communicates with video player 140 on mobile electronic device 10 in video communication sessions for delivery of requested video content. Telephone 20, messaging peer 30 and video server 40 have wired or wireless connectivity with one or more access points (not shown) in network 50, such as cellular base stations and wireless LAN access points. The connectivity may be direct or via one or more intervening data communication nodes such as routers, switches and bridges, in network 50. The one or more access points in network 50 in turn have wireless connectivity with mobile electronic device 10 via one or more over-air links and network interface 105. The over-air links may be any of various known types of links over which data may be transmitted, such as cellular links or LAN links. Mobile electronic device 10 may be a cellular or IP phone, PDA or pocket PC, for example. Data may be exchanged between telephone 20, messaging peer 30 and video server 40, on the one hand, and mobile electronic device 10, on the other, using any of various known communication protocols.

Mobile electronic device 10 includes a processor 110 communicatively coupled between a network interface 105 and user interface elements, which include a display 160 and a keypad 170. Processor 110 is a microprocessor that has an operating system (not shown) running thereon that executes and manages software applications, which include telephony client 120, messaging client 130, video player 140, calendar agent 145 and display manager 150. Calendar agent 145 provides calendaring services, such as schedule recording and reporting, for one or more users of mobile electronic device 10. Display manager 150 is operatively coupled between telephony client 120, messaging client 130, video player 140 and calendar agent 145, on the one hand, and display 160, on the other, and is adapted to regulate the format in which data regarding competing tasks is rendered on display 160. In some embodiments, display 160 includes display driver circuitry (not shown) and an LCD screen and display manager 150 causes display 160 to render data on the LCD screen in a particular format through commands issued to the display device driver circuitry. In some embodiments, keypad 170 is a standard 12-key alpha-numeric telephonic keypad.

An important feature of the present invention is non-intrusively displaying alternative task data to a user of a mobile electronic device with minimal disruption to display of current task data. In one embodiment, this significant feature is realized by rendering a reduced size current task window while rendering an informative dashboard adjacent thereto in response to an event involving the alternative task.

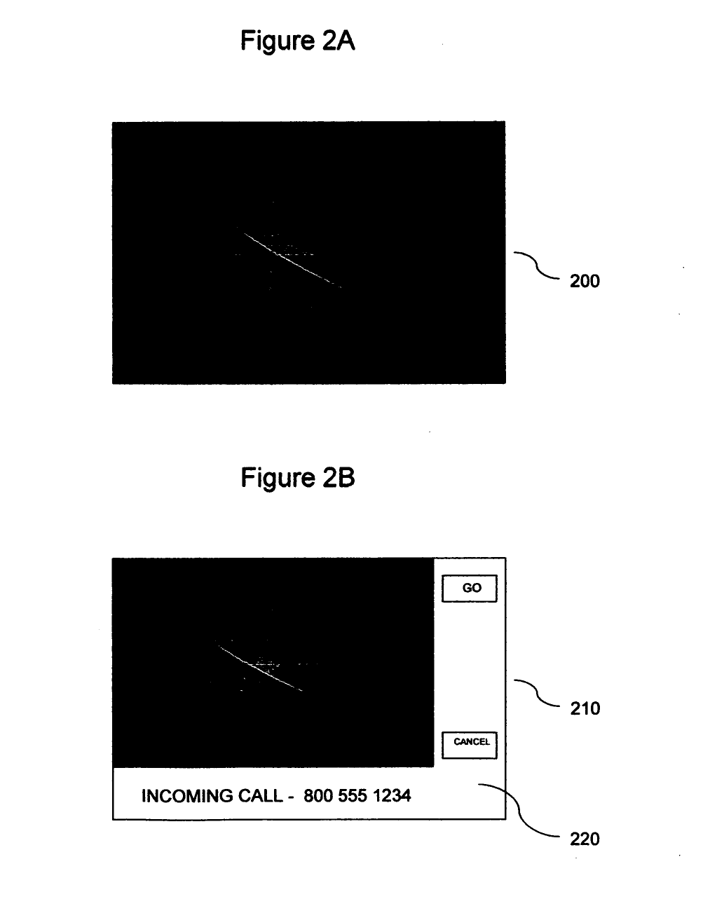

This feature is illustrated conceptually by reference to FIGS. 2A and 2B, which show exemplary screens 200, 210 on display 160. In the example shown, the current task is video player 140, which is preparing and rendering a video feed of solar system images received from video server 40, whereas the alternative task is telephony client 120, which is receiving an incoming voice call from telephone 20. Prior to receipt of the incoming voice call, the video feed is rendered on display 160 in a full-screen window as shown on screen 200. After receipt of the incoming voice call, the video feed is rendered on display 160 in a partial-screen window with an adjacent informative dashboard 220 as shown on screen 210. Dashboard 220 includes incoming call data, for example, the phone number of the caller, and a menu adapted to receive a user selection respecting the incoming voice call, for example, a “GO” button adapted for selection if the user wishes to answer the incoming voice call and a “CANCEL” button adapted for selection if the user wishes to ignore the incoming voice call and return to viewing the video feed in a full-screen format. Dashboard 220 thus in a minimally disruptive way informs the user of alternative task data and provides an on-screen mechanism for the user to select the alternative task or return to non-disruptive viewing of the current task data.

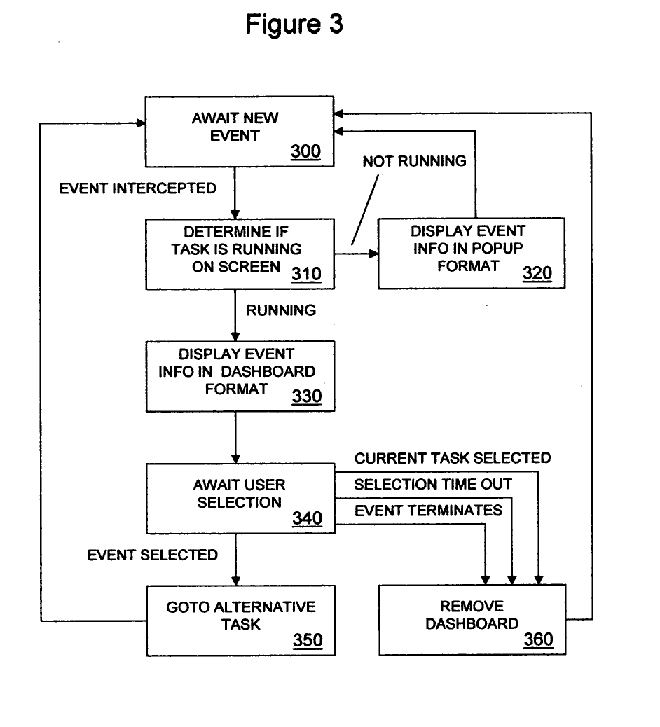

Turning now to FIG. 3, a process flow performed by display manager 150 in one embodiment of the invention is diagrammed. Display manager 150 begins in a listening state in which it awaits a new event (300). A new event may originate on telephony client 120, messaging client 130, video player 140 or calendar agent 145, for example, and may be an incoming voice call received by telephony client 120, an incoming video call, text message or digital image received by messaging client 130, an incoming video feed received by video player 140 or an item scheduled on calendar agent 145, for example. Display manager 150 intercepts the event and determines if a current task is running on the screen of display 160 (310). If no current task is running on the screen, display manager 150 causes information about the event to be rendered on-screen in popup format, such as a full-or partial-screen popup window (320). In some embodiments, display manager 150 may render a popup window by relaying to display driver circuitry, without modification, an intercepted display command issued by telephony client 120, messaging client 130, video player 140 or calendar agent 145. In other embodiments, display manager 150 may issue to display driver circuitry its own display command causing a popup window to be rendered on-screen.

If, on the other hand, a current task is running on the screen of display 160, display manager 150 causes information about the event to be rendered on-screen in dashboard format adjacent the current task (330). In dashboard format, display manager 150, without interrupting the rendering of the current task data, causes the window on display 160 rendering the current task data to be reduced to a predetermined size and renders, adjacent to the reduced window, a dashboard including information about the event. In some embodiments, the reduced window and the dashboard together fill-up the entire screen. The dashboard also displays a menu adapted to receive a user selection respecting the event. In some embodiments, display manager 150 may issue to display driver circuitry a display command causing the reduction of the current task data window and the dashboard in response to a determination that a current task is running on-screen.

Reduction of the current task window to accommodate the dashboard is preferably achieved in a manner sensitive to the user's viewing experience. For example, where the current task is a video feed, in one embodiment the video feed is reduced to fit the reduced window size by selecting lines for continued rendering in substantially equal proportion across the video feed. For example, if the dashboard consumes ⅕ of the screen, the first four lines of the video feed are displayed in the reduced window, the fifth line is skipped, the next four lines of the video feed are displayed in the reduced window, the tenth line is skipped, and so on. Alternatively, the video feed may be truncated at top or bottom to make room for the dashboard.

Display manager 150 next awaits a user selection (340) on the dashboard. If the user selects the event, display manager 150 facilitates a switch from the current task to the alternative task (350). For example, returning to FIG. 2B, if the user selects the “GO” button via an entry on keypad 170, display manager 150 may issue to telephony client 120 a command to answer the incoming call and may issue to video player 140 a command to freeze, at the current frame, the current task window with the solar system video feed. Display manager 150 may then cause to be rendered on dashboard 220 a “RESUME” or similar button (not shown) allowing the user to return to full-screen viewing of the video feed at his or her convenience.

On the other hand, if the user selects the current task rather than the event, or if a predetermined time for a user selection expires without any selection, or if the event terminates, display manager 150 facilitates continuation of the current task (360). For example, by selecting the “CANCEL” button shown in FIG. 2B, display manager 150 may cause dashboard 220 to be removed from display 160 and current task window including the solar system video feed to be rendered once again at full-screen size. In some embodiments, display manager 150 may issue to display driver circuitry a command causing removal of the dashboard and an increase in size of the current task data window in response to user selection of the current task, expiration of a predetermined time for a user selection without any selection, or termination of the event.

After completing handling of the event as described above, display manager 150 returns to the listening state and awaits the next new event (300).

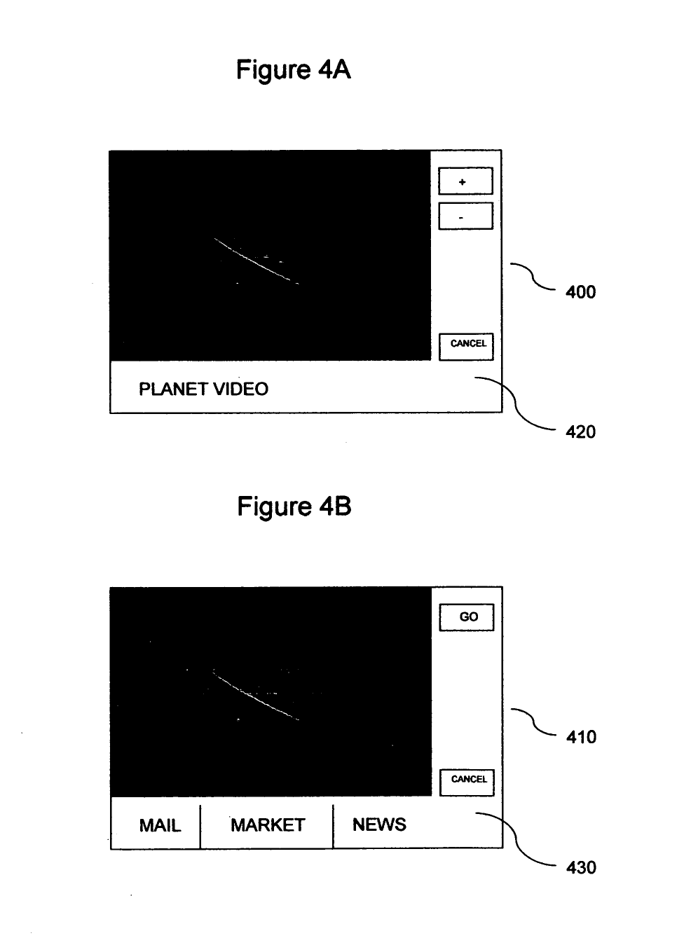

Turning to FIG. 4A an exemplary display screen 400 for a mobile electronic device with a reduced image window and a dashboard 420 having a video channel user selection capability is shown in another embodiment of the invention. In the example shown, the current task is a first video channel rendered on-screen by a video player on the mobile electronic device, whereas alternative tasks unseen on screen 400 exist in the form of alternative video channels received by the video player. The current task data is rendered on screen 400 in a partial-screen window with an adjacent informative dashboard 420. Dashboard 420 includes information about the current task, for example, “PLANET VIDEO” and a menu adapted to receive a user selection respecting the alternative tasks, for example, a “+” button adapted for selection if the user wishes to view the alternative video feed on the next higher alternative video channel and a “−” button adapted for selection if the user wishes to view the alternative video feed on the next lower alternative video channel. The menu also includes a “CANCEL” button adapted for selection if the user wishes to ignore the alternative video channel selections and view the current video feed in a full-screen format. Selections are made by entries on a keypad associated with the mobile electronic device and are processed by a device manager running on the mobile electronic device. Dashboard 420 in a minimally disruptive way provides an on-screen mechanism for the user to select alternative tasks or return to non-disruptive viewing of the current task.

Turning finally to FIG. 4B an exemplary display screen 410 for a mobile electronic device with a reduced image window and a dashboard 430 having a topic user selection capability is shown in yet another embodiment of the invention. In the example shown, the current task is a video player, whereas alternative tasks exist in the form of an email client, a client receiving stock market quotes and a client receiving news headlines. All of the aforementioned clients run on the mobile electronic device. The current task is rendered on screen 410 in a partial-screen window with an adjacent informative dashboard 430. Dashboard 430 includes a menu including icons, for example, “MAIL”, “MARKET” and “NEWS”, a “GO” button adapted for selection if the user wishes to switch to the alternative task indicated by a highlighted icon and a “CANCEL” button adapted for selection if the user wishes to ignore the alternative tasks and return to viewing the video feed in a full-screen window. Selections can be made by entries on a keypad associated with the mobile electronic device and processed by a device manager running on the mobile electronic device. Dashboard 430 in a minimally disruptive way informs the user of the alternative tasks and provides an on-screen mechanism for the user to select the alternative tasks or return to non-disruptive viewing of the current task.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for informing a user of a mobile electronic device of an alternative task, comprising:
rendering on a display of the device in a first size window data from a first task;
detecting on the device an event involving a second task; and
in response to the event, rendering on the display of the device in a second size window the data from the first task while rendering adjacent to the second size window a dashboard adapted to inform the user of the event.

2. The method of claim 1 wherein the dashboard comprises event information and a menu adapted to receive a user selection respecting the event.

3. The method of claim 1 further comprising, in response to a user selection on the dashboard, rendering on the display in a third size window the data from the first task.

4. The method of claim 1 further comprising, in response to expiration of a user selection time limit, rendering on the display in a third size window the data from the first task.

5. The method of claim 1 further comprising, in response to termination of the event, rendering on the display in a third size window the data from the first task.

6. The method of claim 1 wherein the first and second tasks each comprise one of a software application, software process and video channel.

7. The method of claim 1 wherein the data comprise frames from a video feed.

8. The method of claim 1 wherein the event comprises one of an incoming call, an incoming text message, an incoming image and a calendar event.

9. The method of claim 3, wherein the first and third size windows are full-screen windows.

10. A mobile electronic device, comprising:
a processor running a display manager and first and second tasks; and
a display communicatively coupled with the processor and adapted to render data involving the first and second tasks under control of the display manager, wherein in response to an event involving the second task the display manager is adapted to reduce the size of a window on the display rendering data from the first task and render adjacent to the window a dashboard adapted to inform a user of the event.

11. The device of claim 10 wherein the dashboard comprises event information and a menu adapted to receive a user selection respecting the event.

12. The device of claim 10 wherein, in response to a user selection on the dashboard, the display manager is adapted to increase the size of the window rendering data from the first task.

13. The device of claim 10 further comprising, in response to expiration of a user selection time limit, the display manager is adapted to increase the size of the window rendering data from the first task.

14. The device of claim 10 further comprising, in response to termination of the event, the display manager is adapted to increase the size of the window rendering data from the first task.

15. The device of claim 10 wherein the first and second tasks each comprise one of a software application, software process and video channel.

16. The device of claim 10 wherein the data comprise frames from a video feed.

17. The device of claim 10 wherein the event comprises one of an incoming call, an incoming text message, an incoming image and a calendar event.

18. A mobile electronic device, comprising:
a processor running a display manager and first and second tasks; and
a display communicatively coupled with the processor and adapted to render data from the first and second tasks under control of the display manager,
wherein the display manager is adapted to render data from the first task in a window and render adjacent to the window a dashboard having a menu adapted to receive a user selection, and
wherein in response to a user selection the display manager is adapted to render data from the second task in the window in lieu of the data from the first task.

19. The device of claim 18 wherein the menu permits user selection of at least one of email subjects, stock market quotes and news headlines.

20. The device of claim 18 wherein the menu permits user selection of at least one alternative video channel.
